(19) United States
(12) Patent Application Publication
(10) Pub. No.: US 2013/0325664 A1
(43) Pub. Date: Dec. 5, 2013

(54) METHODS AND SYSTEMS FOR PROVIDING INFORMATION RELATED TO AN ITEM THAT IS FOR SALE

(71) Applicants: Joe M. Alegre, Chattanooga, TN (US); Timothy A. Kelly, Chattanooga, TN (US)

(72) Inventors: Joe M. Alegre, Chattanooga, TN (US); Timothy A. Kelly, Chattanooga, TN (US)

(21) Appl. No.: 13/489,341

(22) Filed: Jun. 5, 2012

(51) Int. Cl. G06Q 30/00

(52) U.S. Cl. 705/26.61

(57) ABSTRACT

Information about items for sale is provided to interested parties. Potential buyers who are in physical proximity to the item may electronically submit access information that is obtained from an object present on the item in order to obtain additional information including future electronic communications providing updates to the status or price. The access information may be exposed to potential buyers in various ways including visible scan codes, textable character strings, and the like. A level of interest in the item for sale may be estimated through maintaining a count of the electronic submissions. The interest count can be reported by electronic communication to interested parties including the seller and/or the potential buyers who have submitted the access information. Notifications may also be provided by electronic communications to potential buyers to alert the potential buyer when the item has reached a particular location in a sales queue.

### TECHNICAL FIELD

Embodiments relate to methods and systems that provide information related to an item that is for sale. More particularly, embodiments relate to methods and systems that provide information in relation to a potential buyer being in physical proximity to the item for sale.

### BACKGROUND

The Internet is a valuable tool for presenting items that are for sale to potential buyers. The Internet provides a mechanism to widely disseminate information about the item that is for sale to reach a large number of potential buyers. Typically, an aggregation service that is accessed via the Internet by potential buyers offers a manner of searching an online database that stores information about a substantial number of items for sale. The potential buyers discover the items that are for sale by utilizing the search and display capabilities of the aggregation tool. Often, the aggregation service presents both textual information as well as multi-media information including photographs and video footage of the items to assist the potential buyer in determining the suitability of the item.

In some cases, such aggregation services provide all of the information a potential buyer may need in order to make a purchase decision. However, there are some cases where the conventional aggregation service alone cannot suffice. For instance, some items that are for sale may necessitate that the buyer physically inspect the item prior to purchase. As another example, some buyers may prefer a physical inspection of an item regardless of the type of item to be purchased. Vehicles are an example of items where an Internet based aggregator may assist in finding the vehicle and/or providing information about the vehicle, but physical inspection is desired by many potential buyers before a purchase decision can be made.

Both buyers and sellers alike may find that knowing the degree of legitimate interest in an item for sale by a pool of potential buyers is valuable. For instance, the degree of legitimate interest may dictate a pricing strategy by the buyer. Likewise, the degree of legitimate interest may hasten the buying decision by the potential buyer. Merely tracking a number of web page hits for an item within an aggregator service does not provide an accurate gauge of legitimate interest because of the likelihood of online window shoppers, acts of random browsing, page hits by bots, and the like. This problem is further exacerbated in the case of items that likely require a physical inspection to drive buyer interest, such as vehicles, because even legitimate potential buyers may visit a web page for the item and from that information then have no further interest in purchasing the item. Yet a page count by a conventional aggregator service will treat the interest level of a serious potential buyer the same as the interest level of the disinterested potential buyer, the random browser, the window shopper, and the bot. Thus, the page count is ineffective.

Sellers of items may also prefer to create a sense of urgency among potential buyers. One manner of doing so is to present the level of legitimate interest to the potential buyers to foster a sense of competition among them and to encourage them to make a purchase decision quickly. Another manner of creating a sense of urgency is to adjust the terms of the sale to make the purchase more desirable, such as by lowering the price, offering additional incentives, offering lower financing rates, and the like. However, conventional aggregation services require that the potential buyers take the initiative to monitor for such efforts by the seller and so there is no way to quickly and with certainty stoke the feelings of urgency among the whole pool of potential buyers.

In addition to these issues with the aggregator service, there is also the situation where a potential buyer first encounters the item for sale by physically encountering the item, such as approaching a vehicle for sale on a lot. Conventional aggregator services are not effective in capturing the interest of these potential buyers. Furthermore, conventional aggregator services are not effective in delivering information to these potential buyers, such as the adjustments to the terms of sale that drive the sense of urgency.

### SUMMARY

Embodiments address issues such as these and others by providing information about an item for sale in relation to a potential buyer being in physical proximity to the item. Physical proximity occurs when a potential buyer approaches an item for sale such as a vehicle on a lot. An electronic device of the potential buyer such as a cellphone, smartphone, tablet, and the like generates an electronic submission which includes access information associated with the item. The electronic submission may be in various forms such as a text message of a character string displayed on the item to a specified number, a look-up of a scan code displayed on the item, a selection within a mobile application, and so forth that is initiated by the potential buyer.

The electronic submission evidences that the interest level of the buyer was high enough that upon being in the physical presence of the item, the buyer wanted to obtain additional information and took the initiative to do so. As a result of the electronic submission by each potential buyer, additional information about the item can be provided to the pool of potential buyers, adjustments to the terms of sale can be later disseminated to the pool of potential buyers, and the number of electronic submissions can be counted and provided to interested parties to demonstrate the degree of interest in the item. Furthermore, in the case of selling events such as auctions, alerts can be disseminated to the pool of potential buyers when the item is queued for sale.

Embodiments offer a method of providing information related to an item that is for sale that involves receiving electronic submissions of access information, the access information being indicative of a sender of the electronic submission being in physical proximity to the item. The method further involves providing sales information about the item in an electronic form via a computer network upon receiving each of the electronic submissions of the access information and maintaining a count of a number of the electronic submissions of the access information that are received. Additionally, the method involves providing the count of the number of electronic submissions of the access information to an interested party.

Embodiments offer another method of providing information related to an item that is for sale that involves receiving electronic submissions of access information, the access information being indicative of a sender of the electronic submission being in physical proximity to the item. The method further involves maintaining a registry of electronic addresses related to the electronic submissions of the access information that are received and providing sales information about the item in an electronic form via a computer network to the electronic addresses of the registry upon receiving each of the electronic submissions of the access information. The method additional involves detecting an update to the sales information and sending the updated sales information to the electronic addresses of the registry.

Embodiments offer another method of providing information related to a vehicle that is for sale that involves associating access information with electronic sales information about the vehicle and exposing the access information only on an object that is affixed to the vehicle. The method further involves receiving electronic submissions of the access information, the access information being indicative of a sender of the electronic submission being in physical proximity to the vehicle with the object affixed thereto. Additionally, the method involves providing sales information about the vehicle in an electronic form via a computer network upon receiving each of the electronic submissions of the access information.

Embodiments offer another method of providing information related to an item that is for sale that involves receiving electronic submissions of access information, the access information being indicative of a sender of the electronic submission being in physical proximity to the item. The method further involves maintaining a registry of electronic addresses related to the electronic submissions of the access information that are received and detecting the item being in proximity to a sales queue location. The method further involves sending an alert to the electronic addresses of the registry upon detecting the item being in proximity to the sales queue location.

### DESCRIPTION OF THE DRAWINGS

FIG. 1 shows an example of a system for providing information about items for sale according to various embodiments.

FIG. 2 shows an example of an operational flow for adding potential buyers of an item to a registry and for informing interested parties of the level of interest in the item for sale.

FIG. 3 shows an example of an operational flow for providing information to potential buyers via a mobile application.

FIG. 4 shows an example of an operational flow for providing information to sellers and potential buyers via an online application.

FIG. 5 shows an example of an operational flow for updating potential buyers with changes to sales information.

FIG. 6 shows an example of an operational flow for alerting potential buyers that an item has been queued for sale.

FIG. 7 shows an example of a screen capture of a tool for creating an object that presents information to potential buyers.

### DETAILED DESCRIPTION

Embodiments offer systems and methods that provide information about items for sale. In particular, the systems and methods accommodate potential buyers who are in physical proximity to the item by providing access information with the item, such as a textable character string or a scan code. The access information can be electronically submitted by potential buyers to request additional sales information as well as to subscribe to updates of the sales information in various embodiments. The level of interest in the item for sale as determined by the number of electronic submissions can be tracked and presented to interested parties including the seller and/or potential buyers in various embodiments.

Embodiments further offer systems and methods that can provide information about items for sale in additional manners. Various embodiments may offer additional assistance to sellers by providing a tool for creating a customized object such as a window sticker to be affixed to the item for sale that exposes the access information and may provide some sales information. In situations where the sale of the item occurs at a particular point in time at a physical location, such as at an auction, various embodiments may offer additional assistance to potential buyers by providing a tool for alerting the potential buyer when the item for sale reaches a sales queue location.

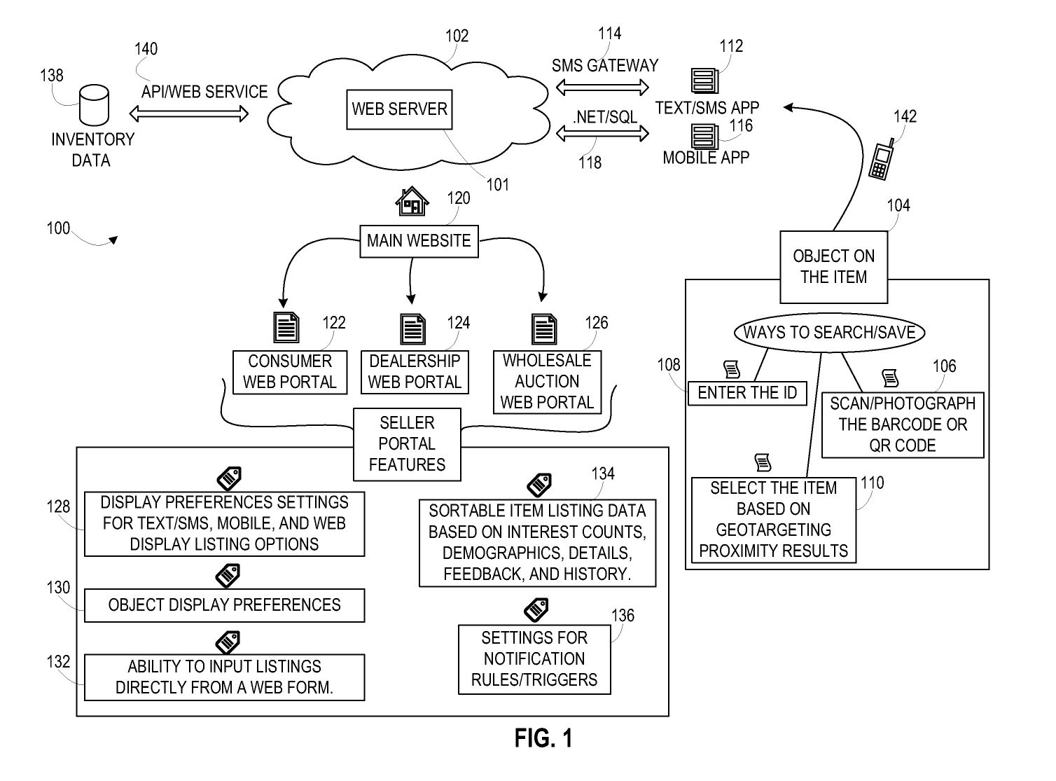

FIG. 1 shows an example of a system 100 that provides information about items for sale. In this system 100, one or more computer servers 101 are connected to a network 102 such as the Internet and provide various functions to facilitate the sale of the item. The computer server 101 communicates externally with an inventory database 138 of a seller through an application programming interface (API), web service, or similar mechanism. For instance, in an example where the items for sale are vehicles, the inventory database 138 may be a dealer management system (DMS), and enterprise resource planning (ERP) system, and the like. Information about the items for sale may be uploaded from the inventory database 138 to the computer server 101 where it can be stored in a structured manner and subsequently searched and disseminated to potential buyers on demand.

The computer server 101 also hosts a website 120 that provides various portals for sellers, whether they are dealers, auctions, or private individuals, to configure the presentation of sales information for an item as well as other preferences for providing information related to the item. For instance, the portal for a seller may provide a display 128 of preference settings for the dissemination of sales information including the item description, status, and price via electronic communications such as text messaging and emails, via mobile applications, and via a website display. A display 130 of preferences for object creation provides a user the ability to configure the object to be affixed to the item for sale, such as to arrange the sales information and the access information to be included on the object such as a window sticker. The portal for the seller may further provide an input function 132 to accept input listings directly from a web form, such as where a private seller may enter the sales information via a web form rather than through an interface 140 to an inventory database 138.

The portal for the seller may also provide additional functionality related to monitoring the progress of selling the item. For instance, the portal may provide a sortable listing 134 of the items for sale where the seller can analyze and sort based on various parameters. One parameter that can be analyzed may be the level of interest that has occurred for each item as represented by interest counts which are discussed in more detail below. Other parameter may include the demographics of potential buyers who have begun to subscribe to sales information about the items, feedback from potential buyers, and other historical information about the progress of selling the items. Additionally, the portal may provide adjustable settings 136 for the rules and triggers related to interest levels and/or other relevant factors that result in notifications being sent to the seller.

The computer server 101 may also provide a portal for consumers who may be potential buyers or sellers. When the consumer enters the portal as a potential buyer, the consumer may filter and view the various listings that have been generated by other sellers in order to discover items for sale that meet desired search criteria.

In order to provide an estimation of the level of interest that may be considered more reliable than conventional methods by at least some sellers, the system 100 may track interest counts. The interest counts may be produced on the basis of receiving an electronic submission of access information that indicates the potential buyer is in physical proximity to the item, as opposed to merely viewing a web page about the item. The access information may be included as a character string 108 that is visible on an object 104 affixed to the item, such as an alpha numeric code on a window sticker of a vehicle. A potential buyer may text the character string 108 from a text application 112 of a device 142 such as a cellphone or smartphone through a mobile service message gateway 114 to a designated contact number to receive additional sales information about the item in return. As another example, the access information may be a scan code 106, such as a bar code or a quick response (QR) code that a mobile application 116 of a smartphone device 142 can capture and electronically submit through a mobile service data gateway 118 to retrieve the additional sales information. As discussed below, the electronic submission may generate an interest count and may also register the potential buyer for future updates and other communications from the server 101.

In another case, the device 142 has location based functionality and implements an appropriate mobile application 116 to view item listings. The mobile application 116 may detect the location of the device 142 and then display a list of only those items that are within close proximity to the device 142, such as within a tenth of a mile. The potential buyer may then select the item of interest 110 from the list which then causes an electronic submission of the access information associated with the selected item from the device 142 through the mobile service data gateway 118 to the computer server 101.

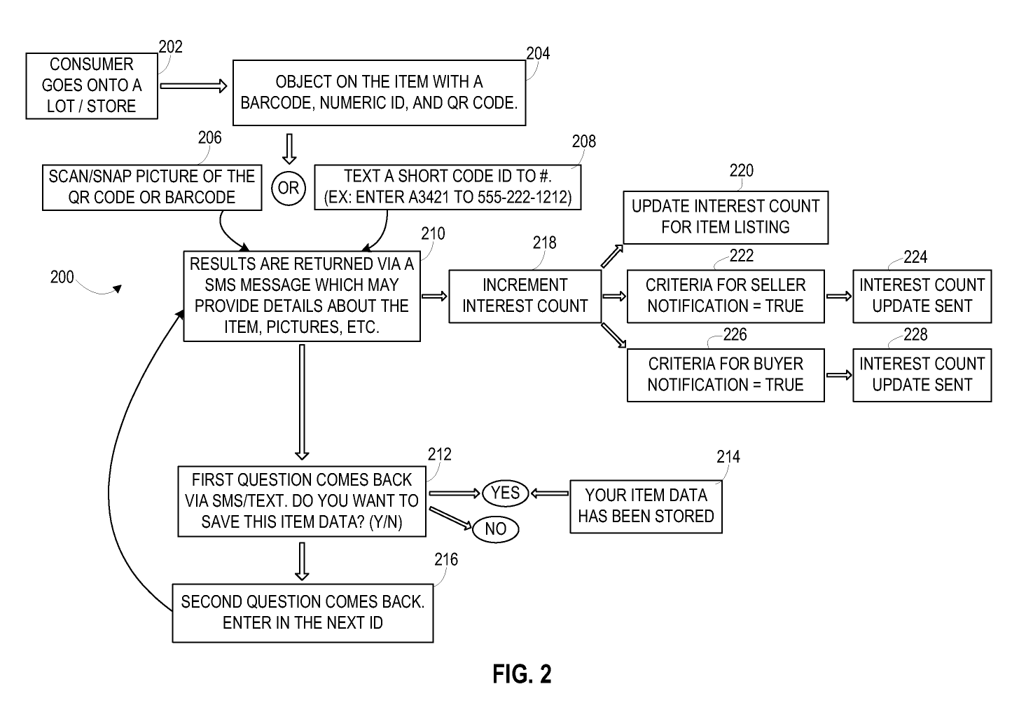

FIG. 2 shows an example of an operational flow that occurs when a potential buyer submits the electronic submission of access information to gain additional sales information and thereby become registered as a potential buyer. Initially, the potential buyer visits a location where an item of interest is located, such as a dealer's lot for a vehicle or any location where a vehicle may be located that is for sale by owner at an action 202. The object that has been previously created by the seller and that includes the access information is observed at an object action 204. The access information in the form of a scan code may be scanned or photographed at an object action 206. The access information in the form of a visible character string may be texted to a designated contact number at an object action 208.

The computer server 101 receives the electronic submission and then performs a look-up of the access information to find the associated item listing and return the sales information of the item listing to the device 142 of the potential buyer at a return action 210. The sales information that is returned may differ depending upon the form of electronic submission that has been received. For instance, if a text message has been received, then a return text message may include only text or additionally a limited amount of multi-media information. Where an electronic submission has been submitted through the mobile service data gateway 118, then a return message may have text or additional multi-media information that may be more extensive than that returned through a text message.

In response to the electronic submission, the computer server 101 may also return additional information, such as sending a question at return action 212 to determine whether the potential buyer wishes to save the item listing to an account. The potential buyer can then revisit the item listing stored in the account assigned to the potential buyer through the consumer portal or mobile application. The account can be identified with the phone number of the device 142. If the potential buyer accepts, then a confirmation is provided at a return action 214. The server computer 101 may also submit a query at a return action 216 for a next item should the potential buyer have interest in other items located in proximity to the potential buyer.

Returning to the action 210, at this point the computer server 101 may also increment an interest count for the item at an increment action 218. The computer server 101 may then update the interest count maintained in the item listing at an update action 220. The computer server 101 may also determine whether the updated interest count meets the criteria for notifying the seller about interest level at an action 222 and then send out an update of the interest count to a designated electronic address of the seller at an update action 224. Similarly, the computer server 101 may also determine whether the updated interest count meets the criteria for notifying each potential buyer about interest level at an action 226 and then send out an update of the interest count to a designated electronic address of each potential buyer at an update action 228.

The interest count may be considered a relatively reliable indicator of the level of interest in the item. The seller may chose to expose the access information only at the item itself to ensure that any electronic submissions of the access information are a direct result of the potential buyer having been in the physical presence of the item.

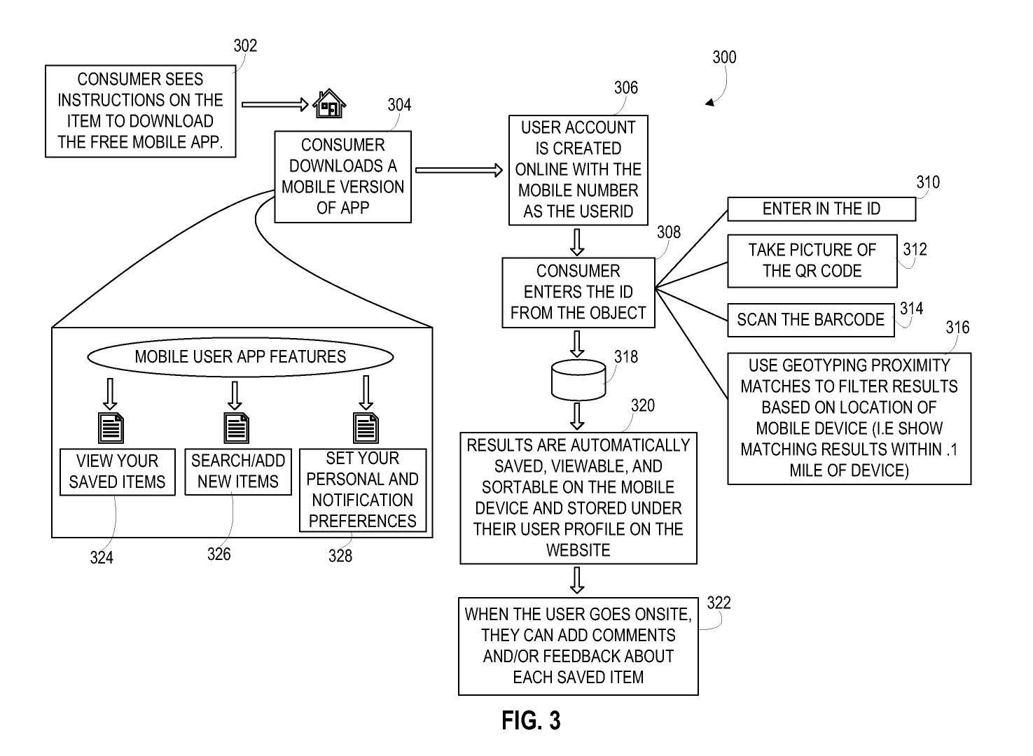

FIG. 3 shows an example of operational flow that occurs when a potential buyer utilizes a mobile application to obtain sales information about an item for sale. Initially, the potential buyer views instructions for obtaining the mobile application located on the object affixed to the item for sale at an observation action 302. The potential buyer then downloads the mobile application to the smartphone device 142 at a download action 304. This download may be provided from the computer server 101 or from another source such as a dedicated online market for applications provided on the device 142.

The mobile application provides various features. As one example, the mobile application allows a potential buyer to view saved item listings 324. As another example, the potential buyer can conduct a search for additional item listings 326 to consider and add to the account. Additionally, the potential buyer can set preferences 328 for various aspects of the service such as the criteria and electronic address to use for notifications including updates to the sales information and updates to the interest count.

Upon running the mobile application on the device 142, a user account is created using the mobile number, or the user logs into the account if one has previously been created at an account action 306. The potential buyer then enters the access information of the item of interest at an action 308. This may include entering the character string 310, the QR code 312, the bar code 314, or making a selection 316 from a geographically filtered list. The access information is electronically submitted to the computer server 101 which accesses the database 318 to return results of the electronic submission that includes the relevant sales information at a return action 320. These results can be viewed and sorted within the mobile application on the device 142. Additionally, the potential buyer can utilize the mobile application while viewing the actual item to augment the saved item listing with feedback and comments at a feedback action 322.

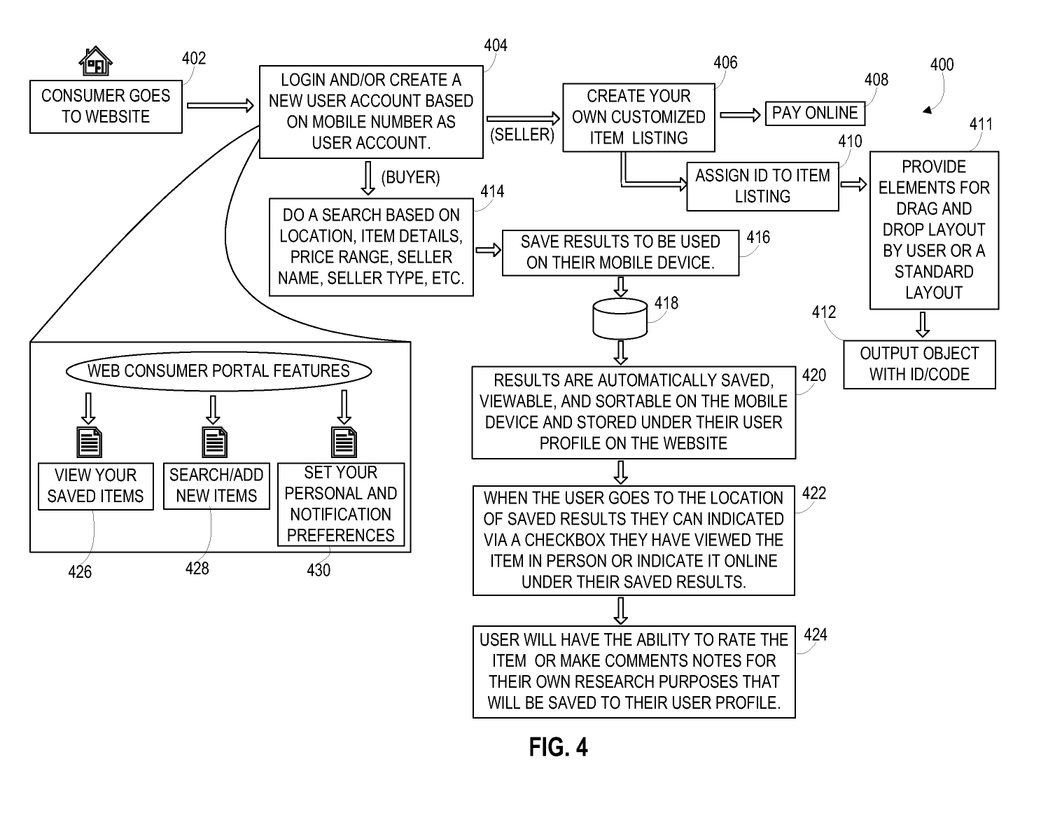

FIG. 4 shows an example of an operational flow that occurs where a consumer, either as a potential buyer or as a seller, visits the website portal at an online action 402. The consumer logs into the account using the mobile number. The consumer portal via the website provides various features including the same options as the mobile application. As one example, the portal allows a consumer to view saved item listings 426. As another example, the consumer can conduct a search for additional item listings 428 to consider and add to the account. Additionally, the consumer can set preferences 430 for various aspects of the service such as the criteria and electronic address to use for notifications including updates to the sales information and updates to the interest count.

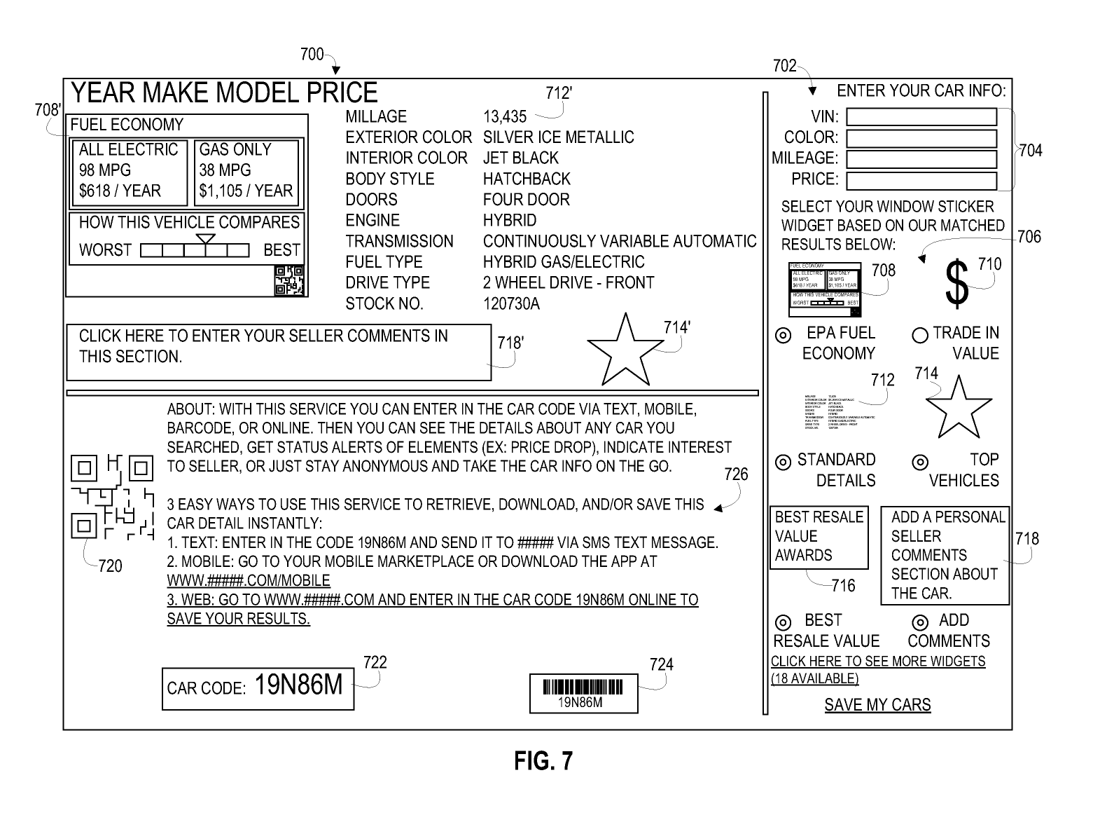

Once logged in, the consumer then makes a selection to either search for items as a potential buyer at a search action 414 or create an item listing as a seller at a listing action 406. Where the consumer wishes to sell an item by creating an item listing, the computer server 101 receives the sales information as input from the consumer to create the listing and then assigns access information to the new listing. The computer server 101 then provides the seller the ability to create an object to affix to the item for sale where the object includes the access information that the computer server 101 has assigned to the new item listing. The computer server 101 may provide a standard object for the seller or alternatively the computer server 101 may provide a customizable object by having selectable and/or drag and drop elements 411 positioned as desired by the user where one or more elements convey some amount of the sales information or the access information. The computer server 101 generates an object with the access information as an output 412 that the seller can then print and attach to the item for sale. The creation of the object, particularly a window sticker for a vehicle, is discussed in more detail below with reference to FIG. 7.

Returning to the account action 404, where the consumer selects to perform a search of item listings at a search action 414, the computer server 101 then saves the results to the user account within the account database 418 at an account action 416. Saving the results in the database 418 makes the results from the search via the website portal being accessible via the mobile application. These results can then be viewed and sorted within the mobile application on the device 142 at action 420. Additionally, the potential buyer can utilize the mobile application while viewing the actual item. For instance, the mobile application may provide a checkbox for each item in the listing that was created online so that upon the potential buyer physically inspecting the item by being in physical proximity to it, checking the box at input action 422 then generates the electronic submission of the access information which updates the interest count and activates update notifications for that item. Embodiments may provide the checkbox for input action 422 only upon the device 142 have a location within a certain distance of the location of the item to ensure that the potential buyer has been in close proximity to the item before updating the interest count. Additionally, the mobile application then allows the potential buyer to augment the saved item listing with feedback and comments at a feedback action 424.

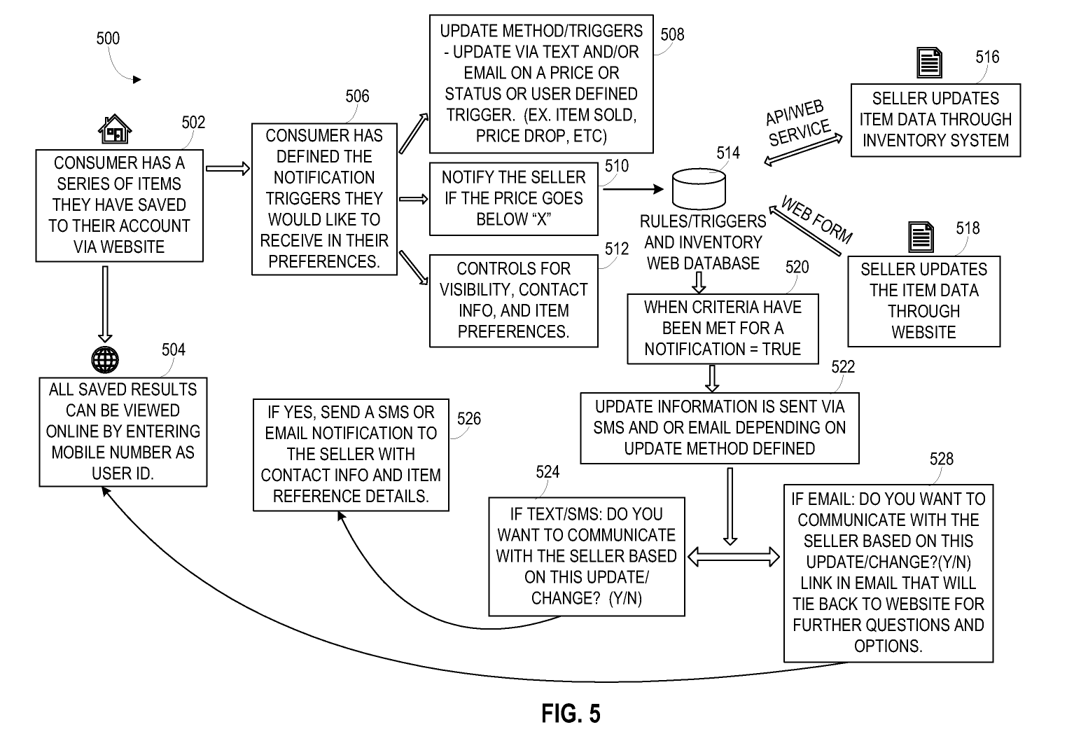

FIG. 5 shows an example of an operational flow where those potential buyers who have become followers or subscribers of a particular item for sale receive updates of the sales information such as the status, price, or other incentives offered by the seller. The potential buyers may become subscribers of an item by being entered into a registry for receiving updates about the particular item when requesting sales information, when saving the item listing to their account as a result of a search, or when otherwise flagging the item listing as being one of interest as in action 502. The potential buyer can access the sales information when desired by using the mobile application or the online website as in action 504.

However, rather than frequently checking the item listing in the mobile application or the online website to discover changes to the status, price, or other sales information for the item, the potential buyer may prefer to be alerted to such changes. Thus, the potential buyer can configure such notification triggers via preference settings of the service that are accessible through the online portal or mobile application at the preferences action 506. Among these preferences, the potential buyer may select which types of electronic communications may be used to provide the alert for a particular trigger such as a sale or price drop as in preference action 508. For instance, the potential buyer may specify a text message and/or an email address where the alert is to be delivered. The potential buyer may also configure more specific triggers, such as setting thresholds for price drops that will generate an alert as in preference action 510. Additionally, the potential buyer may specify additional controls related to privacy, such as whether contact information stored by the service may be exposed to sellers at preference action 512. These preferences are saved to the account information for the potential buyer within a database 514.

Meanwhile, the seller of a given item may update the sales information. For instance, a dealer who utilizes an inventory system that interfaces with the computer server 101 may update a price, status, or other form of sales information within the inventory system that is then transferred into the database 514 as in update action 516. Similarly, a seller may update the sales information for an item through a web form or otherwise on the website portal which then updates the database 514 as in update action 518.

The computer server 101 then detects that the update to the database 514 for an item listing results in criteria for triggering a notification being true for one or more potential buyers who are registered for updates for this particular item as in notification action 520. The computer server 101 then sends the updated information through the chosen form of communication for each potential buyer who is registered for receiving updates for this item in notification action 522. Where the notification is sent via a text message as in text action 524, the text may prompt the potential buyer to respond regarding whether the potential buyer wishes to communicate with the seller in response to the change in sales information that has occurred. If the potential buyer responds in the affirmative, then the computer server 101 may then send an electronic communication to the seller of the item with the contact information for the potential buyer in action 526. Where the notification is sent as an email as in email action 528, the email may prompt the potential buyer to respond with a reply email regarding whether to communicate with the seller regarding the change to the sales information. Furthermore, the email may provide a link back to the item listing on the website where the potential buyer may choose to submit further inquiries to the seller electronically.

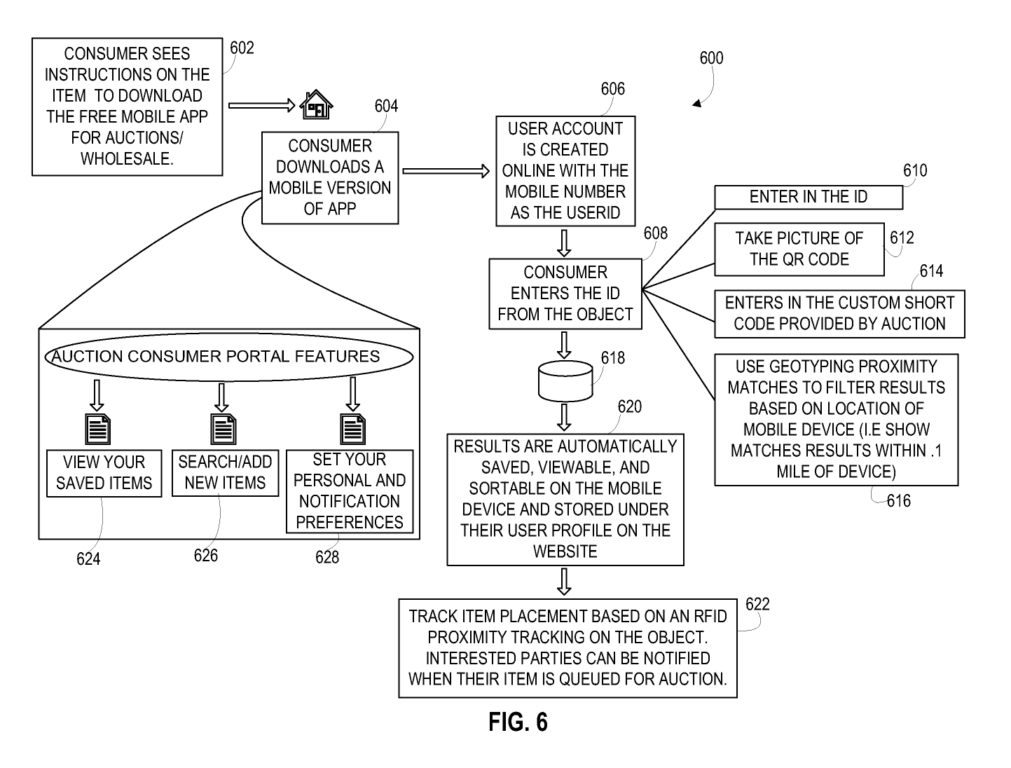

FIG. 6 shows an example 600 of operational flow that may occur to alert potential buyers who have registered for notifications with a particular item listing that the item has reached a particular sales queue location and will therefore be sold very soon. An auction is the typical setting for implementation of these operations. Initially, the potential buyer views instructions for obtaining the mobile application located on the object affixed to the item for sale at an observation action 602. The potential buyer then downloads the mobile application to the smartphone device 142 at a download action 604. This download may be provided from the computer server 101 or from another source such as a dedicated online market for applications provided on the device 142.

As discussed above in the prior examples, the mobile application provides various features. As one example, the mobile application allows a potential buyer to view saved item listings 624. As another example, the potential buyer can conduct a search for additional item listings 626 to consider and add to the account. Additionally, the potential buyer can set preferences 628 for various aspects of the service such as the criteria and electronic address to use for notifications including updates to the sales information, updates to the interest count, and alerts regarding the item of interest reaching the particular sales queue location.

Upon running the mobile application on the device 142, a user account is created using the mobile number or the user logs into the account if one has previously been created at an account action 606. The potential buyer then enters the access information of the item of interest at an action 608. This may include entering the character string 610, the QR code 612, or a code 614 provided by the auction, or making a selection 616 from a geographically filtered list. The access information is electronically submitted to the computer server 101 which accesses the database 618 to return results of the electronic submission that includes the relevant sales information at a return action 620. These results can be viewed and sorted within the mobile application on the device 142. Additionally, the potential buyer can track the placement of the item at the auction or other sales event and be notified when the item reaches the particular sales queue location at a notification action 622.

To facilitate the notification to the potential buyer, the item may be equipped with a radio frequency identification (RFID) tag that identifies the item such as with the same or similar access information included on the object. The auction site may then have an RFID reader positioned at the sales queue location of interest which uploads the access information of the item to the computer server 101, which thereby indicates to the computer server 101 which item is in the sales queue location. This sales queue location may be the location that immediately precedes the sale location. In that case, the potential buyer knows that once the notification is received, the item is the next one to be sold and can then shift attention to that the sale of that item.

FIG. 7 shows an example of a website portal screen capture of an object creation tool. The screen capture shows a preview of the object 700 to be affixed to the item for sale which provides the access information that the device 142 of the potential buyer uploads to the computer server 101. This screen capture also shows a collection of widgets 702 that the seller may utilize to create the object 700 by adding various types of sales information.

This particular example is for vehicles and the object 700 is a window sticker. Among the widgets 702, a set of input fields 704 receive specific information about the vehicle. In some embodiments, a grouping 706 of selectable elements 708-718 allows the seller to choose which types of sales information to include in the window sticker 700. Furthermore, according to some embodiments, the seller may drag and drop the elements to the desired location on the window sticker 700. According to other embodiments, the elements may have predefined locations on the window sticker. Once positioned, the elements 708′-718′ on the window sticker 700 are shown in the proper proportion to the overall size of the window sticker 700 so that the seller can preview the actual appearance.

The computer server 101 assigns the access data to the item listing and then adds the access data to the window sticker 700 in one or more forms along with instructions 726 to the potential buyer regarding how to use the access data to obtain more information. In this example, the access data has been added in the form of a QR code 720, a bar code, and an alpha-numeric character string 722 that can be manually entered for texting to the computer server 101. In some embodiments the window sticker 700 may include a price but instruct the potential buyer to electronically submit the access information to subscribe the price updates. In other embodiments, the window sticker 700 may omit a price so that the potential buyer obtains the current price as well as future pricing updates by electronically submitting the access information.

If the appearance is satisfactory, the seller may then print the window sticker 700 and then affix the window sticker 700 to the vehicle. The potential buyer may then view the window sticker when physically inspecting the vehicle and may then proceed to electronically submit the access information if interested in the vehicle.

While embodiments have been particularly shown and described, it will be understood by those skilled in the art that various other changes in the form and details may be made therein without departing from the spirit and scope of the invention.

What is claimed is:

1. A method of providing information related to an item that is for sale, comprising:
receiving electronic submissions of access information, the access information being indicative of a sender of the electronic submission being in physical proximity to the item;
providing sales information about the item in an electronic form via a computer network upon receiving each of the electronic submissions of the access information;
maintaining a count of a number of the electronic submissions of the access information that are received; and
providing the count of the number of electronic submissions of the access information to an interested party.

2. The method of claim 1, further comprising providing the access information related to the item in physical proximity to the item.

3. The method of claim 2, wherein the access information is a visible character string and wherein the electronic submission is a text message of the visible character string to a specified contact number.

4. The method of claim 2, wherein the access information is a scan code and the electronic submission is a data message sent to an electronic address specified by the scan code.

5. The method of claim 1, further comprising:
detecting a geographical location of an electronic device;
providing the item for selection at the electronic device upon determining from the detected geographical location of the electronic device that the electronic device is in proximity to the item, and wherein the electronic submission is sent by the electronic device upon the item being selected at the electronic device.

6. The method of claim 1, wherein an electronic device presents the item and wherein a user input to the electronic device upon the user having been in proximity to the item causes the electronic device to send the electronic submission.

7. The method of claim 1, wherein the item is a vehicle.

8. The method of claim 1, wherein the interested party is a seller of the item.

9. The method of claim 1, wherein the interested party is a potential buyer of the item.

10. The method of claim 1, wherein providing the count comprises including the count in an electronic communication.

11. A method of providing information related to an item that is for sale, comprising:
receiving electronic submissions of access information, the access information being indicative of a sender of the electronic submission being in physical proximity to the item;
maintaining a registry of electronic addresses related to the electronic submissions of the access information that are received;
providing sales information about the item in an electronic form via a computer network to the electronic addresses of the registry upon receiving each of the electronic submissions of the access information; and
upon detecting an update to the sales information, sending the updated sales information to the electronic addresses of the registry.

12. The method of claim 11, further comprising providing the access information related to the item in physical proximity to the item.

13. The method of claim 12, wherein the access information is a visible character string and wherein the electronic submission is a text message of the visible character string to a specified contact number.

14. The method of claim 12, wherein the access information is a scan code and the electronic submission is a data message sent to an electronic address specified by the scan code.

15. The method of claim 11, further comprising:
detecting a geographical location of an electronic device;
providing the item for selection at the electronic device upon determining from the detected geographical location of the electronic device that the electronic device is in proximity to the item, and wherein the electronic submission is sent by the electronic device upon the item being selected at the electronic device.

16. The method of claim 11, wherein an electronic device presents the item and wherein a user input to the electronic device upon the user having been in proximity to the item causes the electronic device to send the electronic submission.

17. The method of claim 11, wherein detecting the update to the sales information comprises communicating with an electronic system of a seller.

18. The method of claim 11, wherein the update to the sales information comprises a change to the price of the item.

19. The method of claim 11, wherein the update to the sales information comprises a change to the sale status of the item.

20. A method of providing information related to a vehicle that is for sale, comprising:
associating access information with electronic sales information about the vehicle;
exposing the access information only on an object that is affixed to the vehicle;
receiving electronic submissions of the access information, the access information being indicative of a sender of the electronic submission being in physical proximity to the vehicle with the object affixed thereto; and
providing sales information about the vehicle in an electronic form via a computer network upon receiving each of the electronic submissions of the access information.

21. The method of claim 20, wherein the access information is a visible character string and wherein the electronic submission is a text message of the visible character string to a specified contact number.

22. The method of claim 20, wherein the access information is a scan code and the electronic submission is a data message sent to an electronic address specified by the scan code.

23. The method of claim 20, wherein the object is a window sticker.

24. The method of claim 23, further comprising:
receiving the electronic sales information through a portal; and
providing elements of the window sticker, the elements containing the sales information and the access information; and
outputting the window sticker including the elements.

25. The method of claim 24, further comprising receiving user input to position the elements within the window sticker.

26. A method of providing information related to an item that is for sale, comprising:
receiving electronic submissions of access information, the access information being indicative of a sender of the electronic submission being in physical proximity to the item;
maintaining a registry of electronic addresses related to the electronic submissions of the access information that are received;
detecting the item being in proximity to a sales queue location; and
upon detecting the item being in proximity to the sales queue location, sending an alert to the electronic addresses of the registry.

27. The method of claim 26, further comprising providing sales information about the item in an electronic form via a computer network upon receiving each of the electronic submissions of the access information.

28. The method of claim 26, wherein the item is a vehicle and wherein the sales queue location is an auction queue location.

29. The method of claim 26, wherein a radio frequency identification tag is affixed to the item, wherein the sales queue location includes a radio frequency identification tag reader, and wherein detecting the item being in proximity to a sales queue location comprises reading the radio frequency identification tag at the sales queue location.
